(19) United States
(12) Patent Application Publication
(10) Pub. No.: US 2006/0027271 A1
(43) Pub. Date: Feb. 9, 2006

(54) Valve in the region of an internal combustion engine

(75) Inventors: Bernhard Klipfel, Karlsruhe (DE); Hans-Joachim Toepel, Schwetzingen (DE)

Correspondence Address: WOLF GREENFIELD & SACKS, PC;FEDERAL RESERVE PLAZA, 600 ATLANTIC AVENUE, BOSTON, MA, 02210-2211, US

(73) Assignee: Cooper-Standard Automotive (Deutschland) GmbH, Schelklingen (DE)

(21) Appl. No.: 11/157,516

(22) Filed: Jun. 21, 2005

(30) Foreign Application Priority Data
Jun. 25, 2004 (EP) 04014984.1

(51) Int. Cl. F16K 1/18

(52) U.S. Cl. 137/873

(57) ABSTRACT

A valve in the region of an internal combustion engine comprises a conduit (12) for the guidance of a medium, which conduit (12) has a wall, and the valve further comprises a valve member (20) which, in its closed state, is positioned within the conduit (12) and which, at least in its completely opened state, is in alignment at least to a large extent with the adjacent wall of the conduit (12) or is positioned outside same and which helps to guide the medium.

### TECHNICAL FIELD

The invention relates to a valve in the region of an internal combustion engine.

In the field of internal combustion engines, it is often the case that a medium has to be guided through suitable conduits or lines and needs to be connected up, cut off or regulated by means of valves. For instance, the process of returning exhaust gas towards the fresh-air side usually takes place as a function of the operating state in order to reduce fuel consumption and pollutant emissions as a result. In such an instance, one or more exhaust-gas recirculation (EGR) valves are provided. In addition, valves can be provided within the exhaust system so as to release, stop or divert the flow of exhaust gas. Measures of this nature can be used, for example, to regulate the exhaust back pressure and/or to connect up or cut off individual components, such as catalytic converters, filters, radiators or the like. These applications are mentioned merely by way of example.

### PRIOR ART

An EGR valve in which an exhaust-gas feed line protrudes into the suction line is known from DE 27 03 687 A1. Within the suction line there is provided outside the exhaust-gas feed line a throttle valve that ensures that the exhaust-gas feed line is opened or closed.

In the subject matter of DE 195 49 107 A1, too, an exhaust-gas feed line projects into the suction line. At its axial end, the exhaust-gas feed line is closed and radially opened. Over the end of the exhaust-gas feed line there is positioned a so-called rotary gate valve type bell comprising an opening which can be brought into alignment with the opening in the exhaust-gas feed line so as to open or close the latter.

What is known from EP 1 245 820 A1 is an EGR valve, the rotatable valve member of which is supported eccentrically in such a way that, in its opened state, it can be positioned at the edge of the exhaust-gas line in order to affect the flow of exhaust gas as little as possible.

Finally, EP 03 029 491 filed by the Applicant describes an EGR valve that comprises a flow-guidance member behind which a valve member can be positioned in its opened state so as to disrupt the flow of exhaust gas as little as possible.

### DESCRIPTION OF THE INVENTION

The invention is based on the object of designing a valve in the region of an internal combustion engine, which valve is further enhanced with regard to the avoidance of flow losses.

This object is solved by the valve described in claim 1.

The valve according to the invention, which valve is intended and is suitable for installation within an internal combustion engine, therefore comprises on the one hand a conduit for guiding a medium. The medium may for example be exhaust gas, so that the valve according to the invention is used in this case as an exhaust valve or EGR valve. If it is intended as an exhaust valve, it can be provided in the exhaust system so as to stop, release, divert or regulate the flow of exhaust gases. As mentioned at the beginning, these measures can be taken to regulate the exhaust back pressure, to connect up or cut off components such as catalytic converters, filters, radiators and the like, or to modify or influence, for instance, the sound of the exhaust system and hence of the vehicle, or to modify or influence other characteristics. Furthermore, the valve according to the invention may be used as an EGR valve so as to recirculate a flow of exhaust gas towards the engine's fresh-air side or to restrict a flow of air at the engine's intake side. In the case of diesel engines, for example, an increase in the driving pressure gradient can be achieved at the induction side in that a throttle valve provided here is closed completely or to an extent. In addition, diesel engines can be fitted with a so-called added-feature or convenience cut-off facility that is effected by abruptly closing the supply of fresh air. The valve according to the invention is suitable for the aforementioned applications as well.

The aforementioned conduit of the valve according to the invention has a wall. The valve also has a valve member which, in its closed state, is positioned within the conduit. As a result, moreover, the valve according to the invention is particularly suitable as a valve that releases or blocks the flow of a medium without necessarily feeding this flow into a second conduit. Only in the latter instance can the valve member in fact be positioned in the second conduit, and hence in a region outside the first conduit. In contrast thereto, the valve member of the valve according to the invention is located in its closed state within the conduit in which the medium is guided, the intention being to block, release, divert or regulate this medium by means of the valve according to the invention.

Particularly beneficial flow conditions can be brought about by the valve according to the invention in that the valve member, at least in its completely opened state, is in alignment, at least to a large extent, with the adjacent wall of the conduit or is positioned outside same. So as to obtain the aforementioned situation in an opened state, namely an alignment of the valve member with the conduit wall or a configuration outside the conduit wall, at least one recess to be described in more detail below is provided in the conduit wall. On account of this recess, reference will be made to that conduit wall which is adjacent to the valve member so as to describe the position of the valve member in its opened state. It should be mentioned that until the (opened) valve member is achieved, the flow which prevails inside the conduit is determined by the conduit wall, and immediately before the opened valve member is achieved, this flow is determined by the conduit wall adjacent thereto. In the region of the (opened) valve member, the valve member helps to guide the medium. This makes it possible to reduce flow losses by means of simple measures. Unlike in the prior art, no additional flow-guidance member is in fact necessary. On the contrary, in its opened state, the valve member is located in a position in which the valve member helps to guide the medium and simultaneously avoids interference with the flow. In particular, it is possible to speak of the valve member forming, in its opened state, part of the conduit wall. The conduit wall can accordingly be provided as a continuous single wall, and no second inner conduit wall is required, as would be formed by a separate flow-guidance member. For this reason, in particular, the valve member of the valve according to the invention is not concealed in its opened state by other components.

A largely undisrupted flow can be ensured by the measure specified by the invention, namely to design a valve member in such a way that in its opened state, the valve member is in alignment with the adjacent conduit wall or is positioned outside same. The opened valve member is not in fact located within the inside, clear cross-section of the conduit, where it would affect the flow. On the contrary, the valve member, at least in its completely opened state, forms a kind of continuation of the conduit wall and thereby contributes towards the expedient guidance of the medium. Interference can be avoided. This is also particularly true in the case in which the valve member, in its completely opened state, is positioned outside the adjacent conduit wall.

Even though it is enough for the valve member, in its completely opened state, to be largely in alignment with the adjacent conduit wall in order to avoid flow losses adequately, preference is given to the valve member's complete alignment with the conduit wall. Furthermore, as regards the configuration of the valve member outside the adjacent conduit wall, the preference is for the valve member in this state to be likewise completely positioned outside the adjacent conduit wall in order to rule out interference to the flow as far as possible.

In relation to the measure of providing a valve whose valve member, at least in its largely opened state, is at least to a large extent in alignment with the adjacent wall of the conduit, it should be mentioned that in this case, the valve member, particularly in its closed state, does not necessarily have to be positioned within the conduit of the valve. In conjunction with the present application, moreover, it is considered to be an innovation to provide a valve with a valve member which, at least in its completely opened state, is in alignment at least to a large extent with the adjacent conduit wall. This measure can be suitably combined with all the features described above or below.

Preferred embodiments of the valve according to the invention are described in the other claims.

The valve member is preferably designed to be curved as a whole. Even though valve members are known which exhibit curvature on one side, for example the downstream side, the valve member of the valve according to the invention is the first to be curved all over. This makes it possible to achieve the aforementioned configuration, namely the alignment with the adjacent conduit wall and/or the arrangement outside same, in a particularly simple and efficient manner so as to affect the flow as little as possible. In this case, the valve member according to the invention can be designed particularly easily as a result of the fact that it is provided as a single-walled sheet-metal part which for example exhibits the curvature of the conduit wall designed for example as a circular cylinder and which can therefore be positioned in a manner that aligns particularly well with the conduit wall. In relation to this feature, too, it should be mentioned that this feature is considered to be an innovation, regardless of those features which were described above and will be described below and with which this feature can nevertheless be combined. Accordingly, the present application introduces a valve that has a valve member with an overall curved design. In other words, the valve member preferably exhibits curvature at both the upstream side and the downstream side. In a particular embodiment, however, the curvature can, moreover, be provided solely at the upstream side. A concave curvature is preferred for this side, and a convex curvature for the downstream side.

In principle, the measure specified by the invention is suitable for any valve design, irrespective of whether its valve member can be moved in a translatory, rotational or in any other manner. Nonetheless, the current preference is for the valve member to be pivotable and for this valve member, in its completely opened state, to pivot, as it were, into the region of the conduit wall so as to affect the flow as little as possible.

As regards valve-member support, the current preference is for the valve member to be supported centrically. In other words, the support is located at an at least largely centric point relative to the valve member. Furthermore, the support can be preferably designed centrically relative to the conduit in which the valve is provided and preferably centrically relative to the valve's centre line. It is, however, equally conceivable and in no way excluded by the invention for an eccentric type of support to be provided. Such a support can be taken advantage of, for example, so as to use the exhaust-gas pressure that acts upon the valve member to close the valve, or at least to assist the closing movement. The support can equally be provided in such an eccentric manner that the exhaust-gas pressure assists the opening movement. In contrast thereto, the currently preferred embodiment based on centric support entails pressure compensation that results in advantages in certain applications.

As concerns valve-member support, it is also currently preferred for the valve member to be supported on one side. This measure offers cost benefits. It should be mentioned that support on both sides is possible, as well.

Particular advantages can be obtained if the shape of the valve member is arrived at from the sectional curve of a first cylinder with a second cylinder. To determine the sectional curve, the centre lines of both cylinders are preferably perpendicular to one another. As a result, the valve member of the valve according to the invention is particularly suitable for a conduit with a circular cross-section. The (curved) shape of the valve member reflects to an extent the shape of the valve conduit. In consequence, since the valve member, at least in its completely opened state, is in alignment with the adjacent wall, the shape of the conduit wall, in the present instance being in consequence part of the cylinder jacket, is favourable for this purpose. But if the valve member is moved into its closed state, i.e. is rotated for example through 90°, it represents, as described above, part of a cylinder jacket which has to ensure a seal inside the conduit, i.e. within a further cylinder. In consequence, the edges of the valve member are obtained from the sectional curve of a first cylinder, of which the valve member represents a part, with a second cylinder that is formed by the conduit.

The conduit advantageously comprises at least one recess for receiving the valve member in its opened state, the shape of which recess is adapted to the shape of the valve member. As a result, the valve-member configuration according to the invention can be realized by way of particularly simple measures.

In this conjunction, particular preference is given to the fact that the recess is formed by at least one separate wall member in order to ensure particularly simple assembly.

### BRIEF DESCRIPTION OF THE INVENTION

An embodiment of the invention will now be explained in more detail on the basis of the following drawings, in which

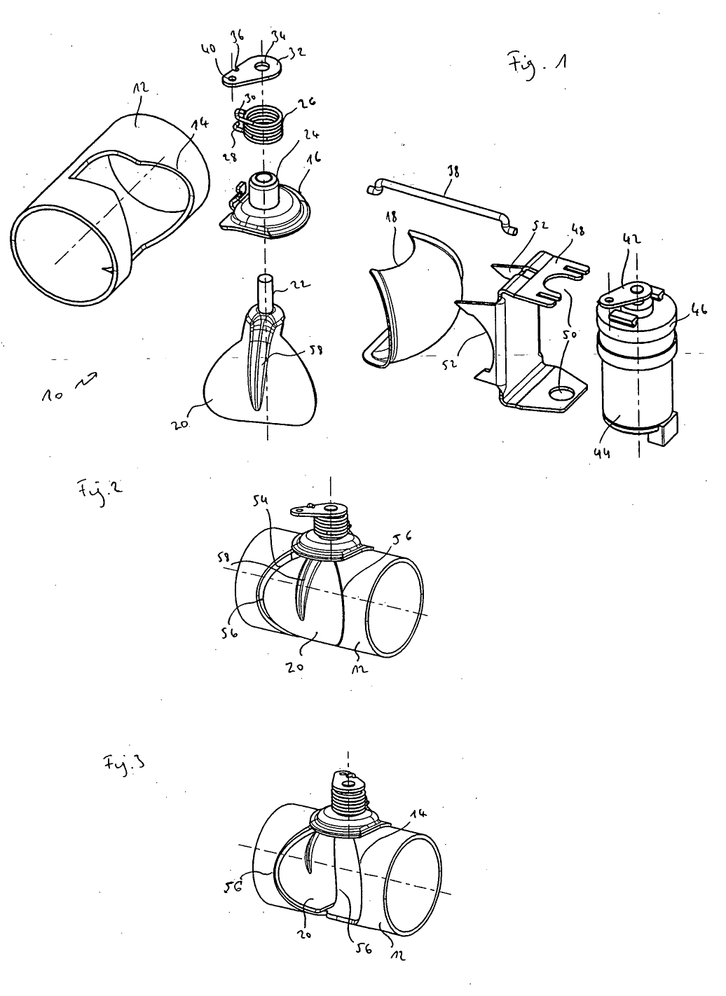

FIG. 1 shows a perspective exploded view of the valve according to the invention;

FIG. 2 shows the valve according to the invention, with the valve member depicted in its opened state; and

FIG. 3 shows the valve according to the invention, with the valve member depicted in its closed state.

### DETAILED DESCRIPTION OF A PREFERRED EMBODIMENT OF THE INVENTION

As can be identified in FIG. 1, the valve 10 according to the invention first has a conduit 12 which, in the example depicted, is designed as a short length of pipe with a largely circular cross-section. It goes without saying, however, that the conduit 12 may also be designed to be longer and it may have a different cross-section. To be able to mount further components of the valve according to the invention, as will be described below, a recess 14, which might also be described as a window, is provided in the wall of the conduit 12. This recess may, for example, be produced using a laser cutting device. In the embodiment depicted, the recess 14 is closed off by two separate wall members, a first bearing wall member 16 and a second wall member 18. The bearing wall member 16 accommodates the support for a valve member 20. In this regard, the valve member 20 comprises a bearing pin 22. Within the bearing wall member 16 a matching bearing bush 24 is provided. Arranged therearound in the depicted embodiment is a flat coil spring 26 which catches, by means of a first hook 28, at the bearing wall member 16 in order to be supported thereon. A second hook 30 is used to connect the flat coil spring 26 to a lever member 32. The lever member 32 is fitted onto the bearing pin 22 by means of an opening 34 formed in the lever member. In the embodiment depicted, the spring 26 pre-tensions the valve member 20 in its open state as a result of the spring's being supported on the bearing wall member 16 and as a result of the further envisaged catching by means of the lever member 32 at a notch 36. The configuration may, however, also be designed in such a way as to envisage the process of pre-tensioning into the closed state, and for the process of opening to be effected against the force of the spring.

In the embodiment shown, closure is effected against the force of the spring 26. To actuate the valve member 20, a rod 38 which is bent in a largely S shape at both ends is provided in this particular embodiment; this rod is inserted at its one end into a second opening 40 within the lever member 32 and is inserted at its second end into a second lever member 42. The second lever member 42 is provided in the region of the drive mechanism. In the embodiment shown, the drive is designed as an electric motor 44 with a set of planetary gear 46 fitted thereon. It is self-apparent, however, that the drive may be designed to be pneumatic, hydraulic or to function in any other suitable manner. It is merely important that, when actuated, the lever member 42 is rotated such that the rod 38 is pulled on or pressure is exerted thereon, thereby causing the lever member 32 to be rotated correspondingly, and the valve member 20 to be actuated.

In the depicted embodiment, the drive 44, 46 is attached to the wall member 18 via a suitably designed retainer 48. The retainer 48 comprises suitable recesses 50 at the sides of the drive 44, 46 in order to insert and secure the drive 44, 46. The retainer 48 has suitable tabs 52 at the sides of the wall member 18 in order to secure the retainer to the wall member 18. In this particular embodiment, the wall member 18, its assembled state, closes off the lateral region of the recess 14. In the same way, the bearing wall member 16 closes off the upper region of the recess 14. As can be seen in FIG. 1, the wall member 18 is provided with a curvature formed toward the outside, thereby forming a recess inside the conduit 12. This recess serves to receive the valve member 20 in its opened state and/or enables the valve member 20 to make the necessary movements.

This opened state is depicted in FIG. 2. In accordance with the invention, the valve member 20, in this completely opened setting, is located in a position in which the valve member is in alignment at least to a large extent with the adjacent wall of the conduit 12. As a result, the flow which passes inside the conduit 12 is affected to a particularly low extent. Only at one side of the valve member 20 is a comparatively small slot 54 provided, which slot is necessary to permit the required pivoting movement of the valve member 20. In this particular case, the valve member can in fact be moved out of the position shown in FIG. 2 and brought into the closed position by rotating it clockwise through 90°. In this closed position, the two edges 56 of the valve member 20 make contact with the inside of the conduit 12.

This is illustrated in FIG. 3. It should be mentioned that the separate wall member 18 including the drive mechanism mounted thereon is omitted in both FIG. 2 and in FIG. 3 so as to portray the conditions more effectively. Nevertheless, it goes without saying that in the operating state, the recess 14 is closed off as a result of the wall member 18. It is equally self-evident that the closure brought about by means of the wall member 18 can be replaced by a further conduit into which the medium passing within the conduit 12 can be diverted. In other words, the depicted embodiment merely enables the flow to be blocked (FIG. 3), released (FIG. 2) or regulated as a result of a suitable intermediate position of the valve member 20. But if instead of the wall member 18, a further conduit follows on, it would be possible to divert the medium that is being guided.

In particular, this diversion would be effected completely in the position shown in FIG. 3. The edges 56 of the valve member 20 are in fact in sealing contact with the inner surfaces of the conduit 12 and prevent the medium from flowing through the conduit 12.

In relation to the two separate wall members 16 and 18, it should be mentioned that they do not necessarily have to be two separate wall members. On the contrary, the valve member 20 including its support and the drive mechanism might be pre-assembled on a single separate wall section and then attached to the conduit 12 provided with the recess 14. This manner of attachment could be designated as a process of “slipping over”. In particular, it is possible in an embodiment in which the support is brought about eccentrically for the necessary separate wall member to cover an angle of 180° or less at the cylinder jacket and thus to be easily assembled. In this respect, an embodiment with an eccentric support and a single separate wall member constitutes a particularly preferred version.

In contrast thereto, the support in the depicted embodiment is centric relative to the valve member 20 and relative to the conduit 12. As mentioned, however, a support that is eccentric or off-centre relative to the valve member 20 and/or the conduit 12 is equally conceivable. Furthermore, the support is effected just at one side. This entails cost benefits compared to an equally conceivable support on two sides.

It can also be seen from the figures that the valve member 20 can be provided as a single-walled component, for example as a sheet-metal part, which is curved in its entirety. In FIGS. 1 and 2, the convex curvature faces the viewer. In FIG. 3, the concave curvature is identifiable. It should, in addition, be mentioned that the valve member in the depicted embodiment is provided with a bead 58 on the side of the convex curvature.

The edges 56 of the valve member 20 are obtained as sectional curves of two cylinders. As can be seen from FIG. 2, the valve member 20, in its opened state, does in fact form part of the cylinder jacket of the conduit 12. In its closed state (cf. FIG. 3), the edges 56 make sealing contact with the inner surface of the conduit 12. What therefore benefits the edges is a shape 56 that is obtained from the fact that the valve member 20, which is obtained (cf. FIG. 2) as a wall portion of the cylinder of the conduit 12, is intersected by the cylinder of the conduit 12, as can be identified in FIG. 3.

1. A valve in the region of an internal combustion engine, in particular an exhaust or exhaust-gas recirculation valve or a valve on the fresh-air side, comprising a conduit for guiding a medium, said conduit having a wall, and said valve further comprising a valve member which, in its closed state, is positioned within said conduit and which, at least in its completely opened state, is in alignment at least to a large extent with the adjacent wall of said conduit or is positioned outside same and helps to guide the medium.

2. A valve according to claim 1, wherein said valve member is curved as a whole.

3. A valve according to claim 1, wherein said valve member is pivotable.

4. A valve according to claim 1, wherein said valve member is supported centrically.

5. A valve according to claim 1, wherein said valve member is supported on one side.

6. A valve according to claim 1, wherein the shape of said valve member is obtained from the sectional curve of a first cylinder with a second cylinder.

7. A valve according to claim 1, wherein said conduit comprises a recess for receiving said valve member in its opened state, the shape of said recess being adapted to the shape of said valve member.

8. A valve according to claim 7, wherein said recess is formed by at least one separate wall member.
